(19) United States
(12) Patent Application Publication
(10) Pub. No.: US 2004/0046038 A1
(43) Pub. Date: Mar. 11, 2004

(54) Blending air apparatus

(76) Inventor: Thomas C. Knowles, High Ridge, MO (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/461,718

(22) Filed: Jun. 13, 2003

Related U.S. Application Data
(63) Continuation of application No. 10/237,276, filed on Sep. 9, 2002, now abandoned.

(51) Int. Cl. G05D 23/00

(52) U.S. Cl. 236/13

(57) ABSTRACT

An air blending apparatus having a housing with at least two air inlet chambers having air flow proportioning means controlling the intake flow of separate return and fresh air streams, an air blending chamber receiving the air streams and being constructed and arranged for intimately intermixing and blending these air streams, and air moving means for distributing the blended air through an air handler system to an enclosed building space.

### PRIOR APPLICATION

This application is a continuation of my co-pending patent application Ser. No. 10/237,276 filed Sep. 9, 2002 for Blended Air Machine (BAM).

### BACKGROUND OF THE INVENTION

1. Field of the Invention

This invention pertains to air handling systems as generally in the HVAC field, and more specifically to improvements in air blending apparatus for blending different air streams for use in ventilation.

2. Description of the Prior Art

Heating, ventilation and air conditioning systems (HVAC) for various building structures frequently require the mixing together of at least two different air streams before final conditioning and distributing the combined air flow through building air ducts. The two air streams most often mixed in an air handling system are return air that is recirculated back from inside the building, and fresh or makeup air brought into the unit from the outside ambient. Seasonal weather conditions produce a wide range of outside air temperatures from the winter cold to extremely hot summer conditions. In inefficient prior systems, the inherent momentum of the moving air streams tends to keep air streams of different temperature stratified in layers, producing false sensor readings and improper control of dampers proportioning the intake air inflow of the respective air streams.

Another problem is that various equipment and building machinery generate large heat loads and environment pollution in factories, assembly plants and other industrial and commercial buildings, and such machinery is often located in poorly ventilated small machine rooms. Even large plant areas are difficult to ventilate at a reasonable cost and can stay very hot all year round, and poor ventilation is known to adversely affect equipment and worker performance. Although thorough admixing of fresh outside air with recirculated inside air has been attempted in the past by using so-called mixing chambers, in actual practice the prior art devices do little more than coadunate the two streams.

### BRIEF SUMMARY OF THE INVENTION

The invention is embodied in an air blending apparatus for air distribution in an enclosed building space comprising a housing having at least two air inlet chambers with controllable air inlets for proportioning the intake flow of recycled return room air and fresh ambient air in separate air streams, a common air blending chamber receiving the air streams and being constructed and arranged for the intimate intermixing and blending thereof, and air moving means for distributing the mixed, blended air to the enclosed space.

The invention is further embodied in the parts and the combinations of parts hereinafter described and claimed.

The principal object of the invention is to provide a blended air apparatus for mixing two different temperature air streams and produce a consistent volume of evenly blended, temperature controlled, air in an air handler system.

Another object is to blend separate air streams in an intimate manner to produce a selected temperature composite air flow for an air delivery system.

Another object is to provide an air blending unit that in the winter will blend an intake of relatively warm return air and an intake of relatively cold fresh ambient air and eliminate stratification thereof; and in other seasons will re-proportion the return and ambient air intake to thereby obtain optimum air temperatures for seasonal conditioning and ventilation of an enclosed building space.

These and other objects and advantages will become more apparent hereinafter.

### BRIEF DESCRIPTION OF THE DRAWINGS

In the accompanying drawings, like numerals refer to like parts wherever they occur:

FIG. 1 is a perspective view showing a blended air apparatus embodying the invention,

FIG. 2 is a cross-sectional elevation of the blended air apparatus to illustrate the internal air chambers, dampers and baffles,

FIG. 3A is a view similar to FIG. 2, but showing the alternate maximum air flow patterns,

FIG. 3B is a view similar to FIG. 3A but showing a representative air flow blending pattern in the air blending apparatus, and

FIG. 4 is a diagrammatic view of the blended air apparatus as typically installed for air distribution to an enclosed space.

### DESCRIPTION OF THE PREFERRED EMBODIMENT

This application is a continuation of my co-pending parent patent application Ser. No. 10/237,276 filed Sep. 9, 2002 for Blended Air Machine (BAM), that I prepared and filed pro se and the disclosure of which is incorporated by reference herein in its entirety. It may be noted that the drawings of the parent application include specific dimensions, as well as legends, in a best embodiment showing of my invention.

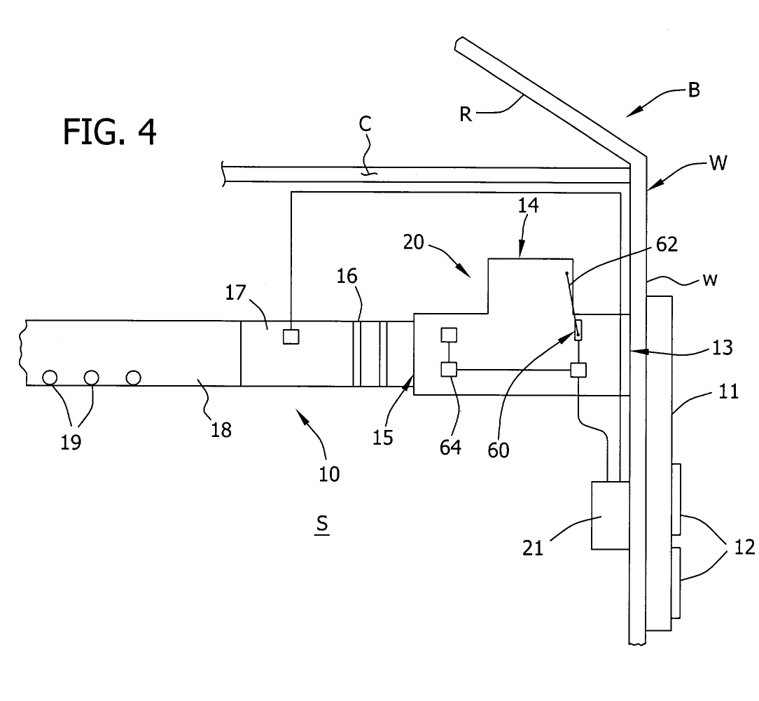

An air blending apparatus 20 embodying the present invention is shown mounted in an air handler or distribution system 10 for providing conditioned air to the selected enclosed space S of building B. Referring first to FIG. 4, the air distribution system 10 is diagrammatically illustrated for environmental purposes as being mounted at or near ceiling C, below roof R and adjacent to outside wall W of the building B. As illustrated, the basic components of the air handler system include an ambient or fresh air intake ductwork 11 having an intake filter rack 12 through which fresh ambient air is drawn from outside the building into the air blending apparatus 20, generally at inlet 13. Recycled return air from inside the building B is drawn into the air blending apparatus 20, generally at inlet 14. The intake of these separate air streams and the blending thereof will be described in greater detail.

The air blending apparatus also has an air delivery or discharge outlet, generally at 15, that is connected by mating collar 16 to a direct drive axial fan (not shown) in fan housing 17, which fan delivers a continuous output of high volume of conditioned air (i.e. 5000 CFM) to the main air distribution duct 18 for discharge into the enclosed space S through a suitable grill or duct openings 19. A control panel 21 is suitably located for operating the apparatus, as will appear.

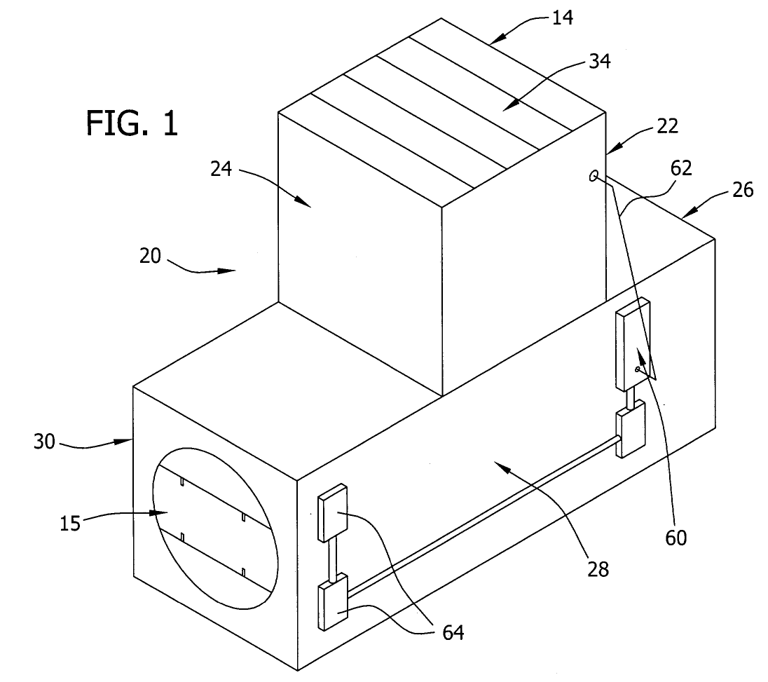

Referring now to FIGS. 1-3, the air blending apparatus 20 comprises a main housing or cabinet 22 having a return air intake section 24, an outside or fresh air intake section 26, a central air blending section 28 and an outlet or air discharge section 30. The return air section 24 forms a return intake air chamber 32 with its inlet 14 being open or otherwise connected to the enclosed space S from which room air is recirculated back through to the return air inlet 14 into the apparatus 20 in a typical negative pressure flow created by the primary air mover 17, as is well known to those skilled in the art. The amount of return air entering the return air chamber 32 is controlled by ganged sets of normally closed horizontally extending dampers 34. These dampers 34 are of the type having opposed pairs of blades 35 that are reversely acting to move from a first in-line planar relationship when fully closed to a second variable angled relationship during modulation toward open (as shown), and finally to a third parallel relationship when fully open. In the second or intermediate modulation position, the blades 35 form a series of tapering air passages or throats that, with the high speed fan 17, contribute to an increased air velocity therethrough. The return air inlet 14 is shown as being on a horizontal top wall area of the housing 22, but it will be understood that the inlet 22 could be constructed and arranged in a side wall (44 or 45) of the return air section 32. Similarly, the fresh outside air section 26 forms a fresh air intake chamber 36 with its inlet 13 being connected to the fresh air intake ductwork 11 through which fresh ambient air is drawn into the air blending apparatus 20. The amount of fresh ambient air entering the chamber 36 is controlled by ganged sets of normally closed vertically extending dampers 37. These dampers 37 also have opposed pairs of blades 38 that are reversely acting to move from fully closed first in-line positions through second variable angled positions to a third fully open position, as described with reference to the blades 35. The return air chamber 32 and make-up air chamber 36 both communicate directly to the central air blending section 28 at the upper region thereof. Air mixing driving damper modulation takes place generally in the control area of the air blending section 28. The air discharge section 30 has a discharge chamber 39 that communicates with the lower area of the central air blending section 28 and has a circular discharge outlet 15 that accommodates the mating collar 16 connecting the fan housing 17.

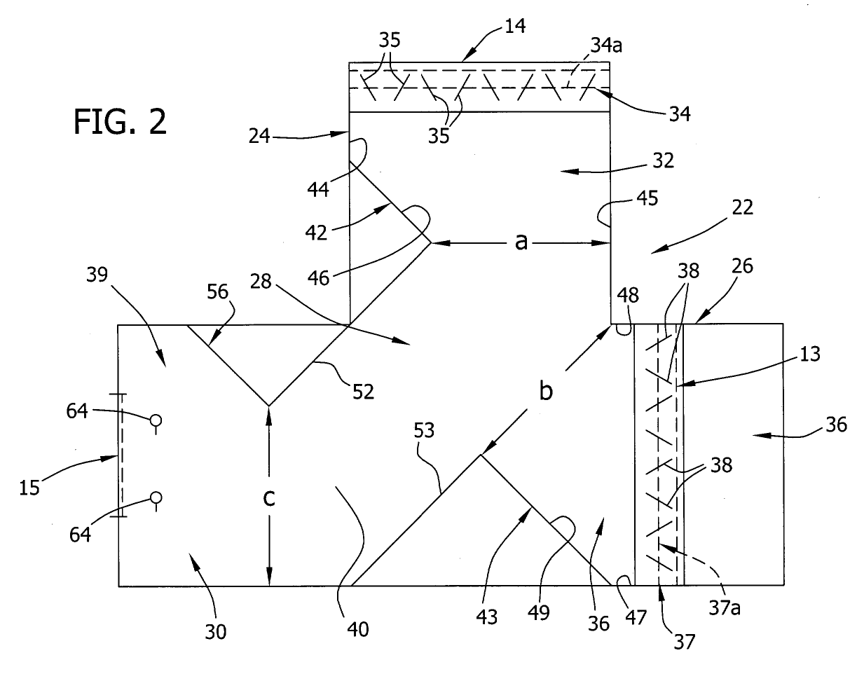

A principal feature of the invention is to provide for the intimate blending of the two separate incoming air streams from the return air intake chamber 32 and the fresh air intake chamber 36. The air blending section 28 is centrally positioned in the main housing 22 and defines a main air intermixing and blending chamber 40 having its upper air inlet zone defined in part by air flow directing baffle means; namely, return air flow baffle 42 and fresh air flow baffle 43. The return air baffle 42 is constructed and arranged to slope angularly from side wall 44 of the return air chamber 32 toward the opposed chamber side wall 45 and constricts air flow across line “a” as shown in FIG. 2. The baffle 42 has an air control surface 46 that is substantially aligned with the vertical center of the fresh air intake dampers 37. Thus, the surface 46 slants directly toward the middle of the incoming fresh air flow in air chamber 36, and the baffle 42 creates a plenum effect in the return air intake chamber 32 when the dampers 34 are fully open. The fresh air flow baffle 43 is also constructed and arranged to slope angularly from a side wall 47 of the fresh air chamber 36 toward the opposed chamber wall 48 and constrict air flow across line “b” (FIG. 2) to create a plenum effect in the fresh air chamber 36 when the dampers 37 are fully open. The angularity of the air control surface 49 is directed across the central chamber 40 to downstream of point “a” on the return air control surface 46 of baffle 42.

Still referring to FIG. 2, the central chamber 40 is defined, in part, by opposed side walls 52 and 53 having substantially the same air flow cross-sectional area dimension as at the respective points “a” and “b”, and it may be noted that the outflow area from the central chamber 40, at “c” in FIG. 2, is substantially the same as at “a” and “b” where an outflow baffle 56 is also formed in part by side wall 52. Air flow is thus channeled to the air outflow or discharge chamber 39 which has a circular discharge outlet 15 from a square housing section 30, whereby a further plenum effect is created back through the central chamber 40.

The two opposed-blade sets of air dampers 34 and 37 at the return air inlet 14 and fresh air inlet 13 are reversely operated as through a bell-crank linkage 62 having crank arms (not shown) connected to the drive shafts 34a, 37a of the respective sets of dampers 34, 37. This provides synchronized operation of both dampers in reversely opening and closing modulation. In one form of motor control for the dampers, a proportional modulation motor (not shown) may be mounted directly to one of the damper drive shafts (34a, 37a), and has a spring return that biases that damper to the closed position. It may also be noted that because of the reverse volume of air intake through both air inlets 34, 37 will be approximately the same and will not exceed the maximum volume that can be achieved through either inlet. Thus, because of the baffling constriction (at “a”-“b”-“c”), the volumetric air flow through the central chamber 40 will be controlled and less than the maximum intake potential since the cross-sectional area of either intake 34, 37 exceeds the cross-sectional area of the central chamber duct. Opposed sets of temperature sensors 64 are positioned in the air outflow section 39 for sensing the temperature of discharge air, and the control panel 21 has an electronic thermostat (not shown) receiving the sensed air temperature readings and is programmed to drive the actuator motor 60 to operate the dampers 34, 37.

In operation each set of dampers 34 and 37 can be modulated from the first fully closed air blocking position to the third fully open (100%) air intake position. When one damper (34) is fully open, the other (37) is fully closed. The air blending apparatus 20 is designed to maximize the supply of fresh (oxygenated) outside air into the building space S for dissipation of excessive machinery heat and fumes and ventilation of dead air spaces in and around such machinery. It is known that the temperatures in such enclosed building spaces can often exceed 120° F. Thus, in spring-summer-fall operations when outside air temperatures may exceed a typical set point temperature in the range of 65° F. to 70° F.—and even reach summer heats of 100° F.—it is desirable to employ 100% fresh outside air to ventilate the building space. When the inside air temperature is 5° F. or more higher than the outside air temperature and exceeds the sensed set point temperature, the position of the respective dampers will generally be modulated in an intermediate range such as 40% open to 60% open to selectively proportion the return and fresh air to maintain supply air temperature set point. When the inside return air temperature drops below the set point, the fresh air inlet will be modulated closed to reflect up to 100% supply of return air. The reversely acting linkage 62 establishes a variable air intake ratio between the two inlets 13, 14 and is essential in providing an unrestricted flow of proportioned air to the main fan 17 for distribution. The dampers 34 and 37 are thus driven to the preselected positions necessary to approximate or achieve set-point temperatures in normal operation. It will be understood by those skilled in the art that other sensors (not shown) of ambient and return air temperatures can also be provided, and the controller 21 may be a programmed microprocessor to achieve optimum temperature and fresh air control.

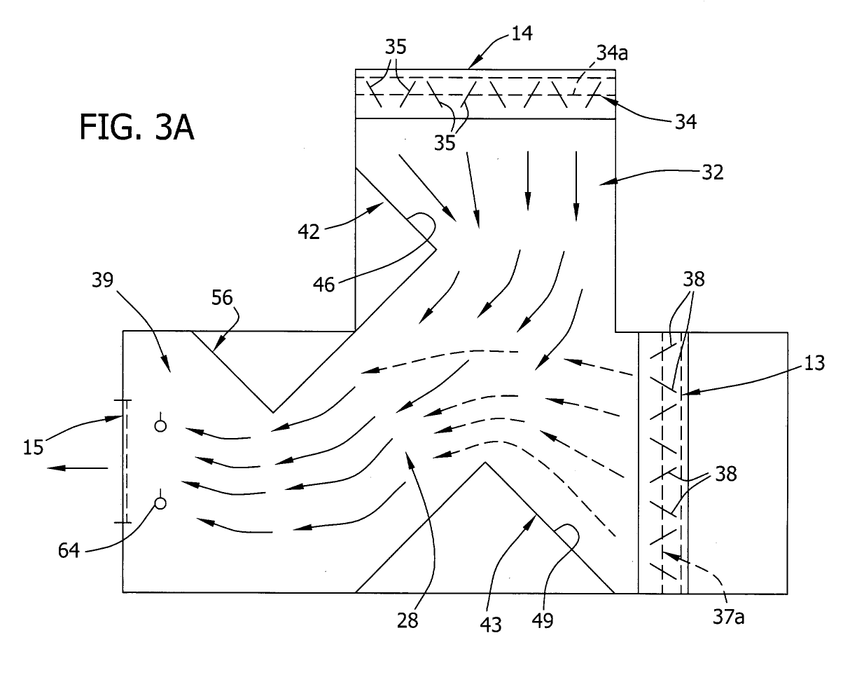

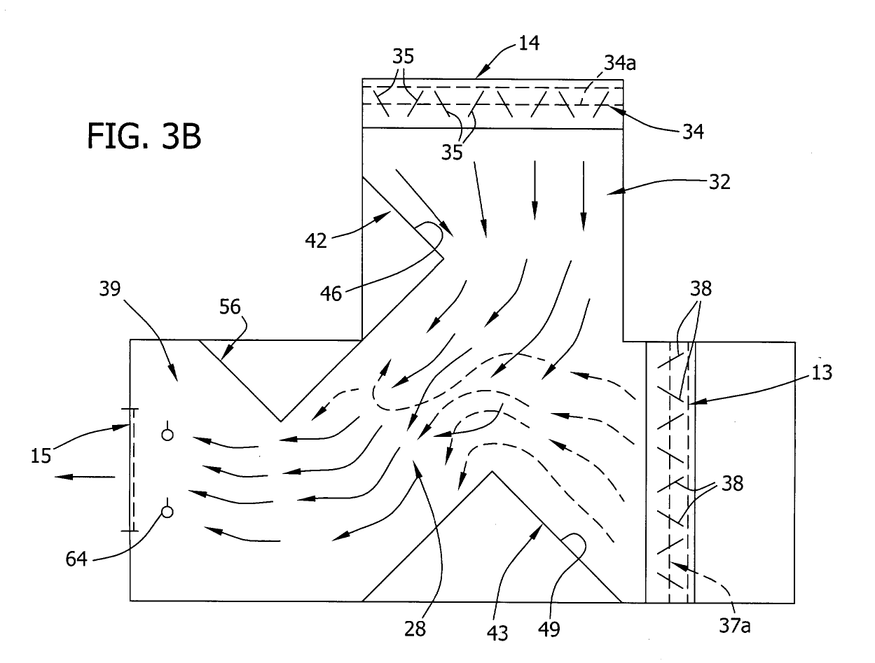

An important feature of the present invention is to provide for a total blending of the two incoming air streams of return and fresh air. The air control means for achieving thorough admixing and blending includes the primary baffle means 42 and 43. The air flow directions of air entering dampers 34 and 37 is substantially perpendicular to each other, but become non-orthogonal due to baffle surfaces 46 and 49. Due to the extreme negative draw created by the fan 17, the entire area of the central chamber 28 is consumed by the movement of at least 5000 cfm of air transitioning through it. The smooth interior surfaces within the apparatus pose little resistance except for baffling redirection. When either damper 34 or 37 is fully 100% open (in the third position), there is minimum turbulence in the air flow through the central chamber 28. When the dampers 34, 37 are modulated into second air proportioning and blending positions, the angled damper blade sets (35, 38) produce an increase in velocity based on the variable throat opening. Thus return air entering area 32 through damper 34 has an increase in velocity as it channels through constricting point “a” formed by baffle side 46 and wall 45. The outside air entering area 36 through damper 37 also has a similar increase in velocity due to constricting baffle side 49 at point “b”. With the two air streams converging at different volumes, velocities and directions, varying turbulence factors will be created in the central chamber 28 and these air streams will be blended together. As the co-mingled or blended air stream is formed in the central chamber, it will be channeled past point “c” by baffle walls 52,53 to the discharge chamber 30 where the restricted outlet size (15) will again influence blending enhanced again by the spiral or rotational air movement created by the fan 17. This air blending is particularly relevant during winter operations when ambient temperatures can be extremely cold (i.e. below zero) and a complete blending of even small proportions of cold air into the return air is important to avoid false sensor readings. This air stream blending is achieved through the highly turbulent air flow conditions generated by the fan 17, the veriable velocities created by damper blades 35,38, and baffle means 42,43, as illustrated in FIG. 3B.

The invention is intended to cover changes and modifications that will be apparent to those skilled in the art, and is of the full scope of the appended claims.

1. An air blending apparatus for supplying conditioned air to an enclosed building space, comprising:
a housing having a first return air chamber with a return air inlet in communication with the enclosed space and having first air proportioning damper means,
a second fresh air chamber with a fresh air inlet in communication with ambient air from outside the enclosed space and having second air proportioning damper means,
an air blending chamber in said housing for receiving and blending separate first and second air streams from the respective first and second air chambers, and control means for operating the first and second damper means to variably proportion the air volume of said respective first and second air streams,
air flow means for directing the flow of at least one of said first and second air streams into a blending relationship with the other of the first and second air streams in said air blending chamber.

2. The air blending apparatus of claim 1 in which at least one of said return and fresh air inlets has an air intake area larger than the cross-sectional area of the air blending chamber.

3. The air blending apparatus of claim 2 in which the air intake areas of both the return air inlet and fresh air inlet are substantially the same.

4. The air blending apparatus of claim 3 where in the first damper means and the second damper means are reversely operated to maintain a substantially constant volume of air flow through the air blending chamber.

5. The air blending apparatus of claim 4 wherein the volume of air flow through either of the return air inlet and fresh air inlet can vary from 100% to zero.

6. The air blending apparatus of claim 5, wherein an air flow volume of about 100% from either of said return or fresh air inlets produces a substantially laminar air flow through the air bending chamber.

7. The air blending apparatus of claim 5 wherein a proportioned air flow in the range of 70-30% from the respective air inlets produces a high degree of blending in the air blending chamber.

8. The air blending apparatus according to claim 1, in which said air flow means comprises baffle means downstream of at least one of said return air inlet and fresh air inlet, said baffle means being constructed and arranged to constrict the air flow passageway from said one of said air inlets into said air blending chamber.

9. The air blending apparatus of claim 8, in which said baffle means is provided downstream of both air inlets.

10. The air blending apparatus of claim 8, in which said baffle means has an air directing surface that is angularly formed toward an upper blending zone of said air blending chamber and toward the air chamber from the other said return air inlet and fresh air inlet.

11. The air blending apparatus of claim 8 in which inlet chamber constricting baffle means are formed downstream of both the return air inlet and the fresh air inlet, said baffle means in each inlet chamber being angularly positioned to direct the respective air flows toward each other to meet and blend in a central blending zone of the air blending chamber.

12. The air blending apparatus of claim 1 including an air outlet for discharging blended air flow outward to the enclosed space, and in which said control means for operating the first and second damper means comprises plural temperature sensors arranged at the air outlet.

13. The air blending apparatus of claim 12, in which said air flow means includes high volume air moving means producing high velocity air flow movement from the respective first and second air chambers through said apparatus.

14. The air blending apparatus of claim 4, in which said first and second damper means each comprise at least two sets of oppositely acting blades movable from a fully closed position to a fully open position through an intermediate variable air modulating position.

15. The air blending apparatus of claim 14, in which said each set of oppositely acting blades are constructed to form variable throat openings whereby to constrict air flow therethrough and increase air velocity.

16. An air blending apparatus for supplying conditioned air to an enclosed building space, comprising:
a housing having a first return air chamber with a return air inlet in communication with the enclosed space and having first air proportioning damper means with at least one set of oppositely acting blades,
a second fresh air chamber with a fresh air inlet in communication with ambient air from outside the enclosed space and having second air proportioning damper means with at least one set of oppositely acting blades,
an air blending chamber in said housing for receiving and blending separate first and second air streams from the respective first and second air chambers,
control means for operating the first and second damper means to variably proportion the air volume of said respective first and second air streams including temperature sensing means down stream of said blending chamber, and
air flow means for directing the flow of at least one of said first and second air streams into a blending relationship with the other of the first and second air streams in said air blending chamber, said air flow means down stream of the respective first and second air chambers and forming air flow constrictions.
